(19) United States
(12) Patent Application Publication
(10) Pub. No.: US 2010/0054158 A1
(43) Pub. Date: Mar. 4, 2010

(54) Method and apparatus for managing multiple media streams during call setup

(76) Inventors: Stinson Samuel Mathai, Wheaton, IL (US); Todd Cartwright Morgan, Oak Park, IL (US); Gregory Tevonian, Norht Aurora, IL (US)

Correspondence Address: Alcatel- Lucent, Docket Administrator - Room 2F-192, 600-700, Mountain Ave.,, Murray Hill, NJ, 07974-0636, US

(21) Appl. No.: 12/290,540

(22) Filed: Oct. 31, 2008

Related U.S. Application Data
(60) Provisional application No. 61/191,013, filed on Sep. 4, 2008.

(51) Int. Cl. H04L 12/16; H04W 4/00

(52) U.S. Cl. 370/259; 455/414.1

(57) ABSTRACT

To address the need to manage multiple media streams within the communication network rather than at the user equipment, the network may employ a method such as that depicted in diagram 10. The network determines (11) that a called remote unit is associated with a personalized service that provides a first media stream for a calling remote unit during setup of a multimedia session. The network then indicates (12) to network equipment supporting the setup of the multimedia session to not provide a second media stream for the calling remote unit during the setup of the session. In response to receiving (13) an indication that the called remote unit is accepting the multimedia session, the network indicates (14) to network equipment to remove the first media stream from the calling remote unit and establish a media path between the called remote unit and the calling remote unit.

### REFERENCE(S) TO RELATED APPLICATION(S)

The present application claims priority from a provisional application Ser. No. 61/191,013, entitled “METHOD AND APPARATUS FOR MANAGING MULTIPLE MEDIA STREAMS DURING CALL SETUP,” filed Sep. 4, 2008, which is commonly owned and incorporated herein by reference in its entirety.

### FIELD OF THE INVENTION

The present invention relates generally to communication systems and, in particular, to managing multiple media streams during call setup.

### BACKGROUND OF THE INVENTION

In telecommunication systems, scenarios exist in which multiple sources may concurrently play media to the same device. In such situations, incoherent mixing of packets from the different media streams may result. Moreover, in wireless systems, the undesired or interfering media streams may waste scarce wireless resources. Wireless user equipment (UEs) can be designed to manage multiple media streams and avoid incoherently playing multiple streams to users; however, this adds complexity to the UE devices and does not avoid the inefficient utilization of wireless bandwidth. Thus, it would be desirable to have a method and apparatus for managing multiple media streams within the communication network rather than at the UE.

### BRIEF DESCRIPTION OF THE DRAWINGS

FIG. 1 is a logic flow diagram of functionality performed by a communications network in accordance with multiple embodiments of the present invention.

FIG. 2 is a block diagram depiction of a wireless communication system in accordance with multiple embodiments of the present invention.

FIG. 3 is a more detailed block diagram depiction of a wireless communication system in accordance with certain embodiments of the present invention.

FIGS. 4A-4F, considered together (hereinafter “FIG. 4”), form an exemplary signaling flow diagram that depicts media session setup between user equipment (UEs) that support Session Initiation Protocol (SIP) forking, in accordance with certain embodiments of the present invention.

FIGS. 5A-5I, considered together (hereinafter “FIG. 5”), form an exemplary signaling flow diagram that depicts media session setup between user equipment (UEs) that do not support Session Initiation Protocol (SIP) forking, in accordance with certain embodiments of the present invention.

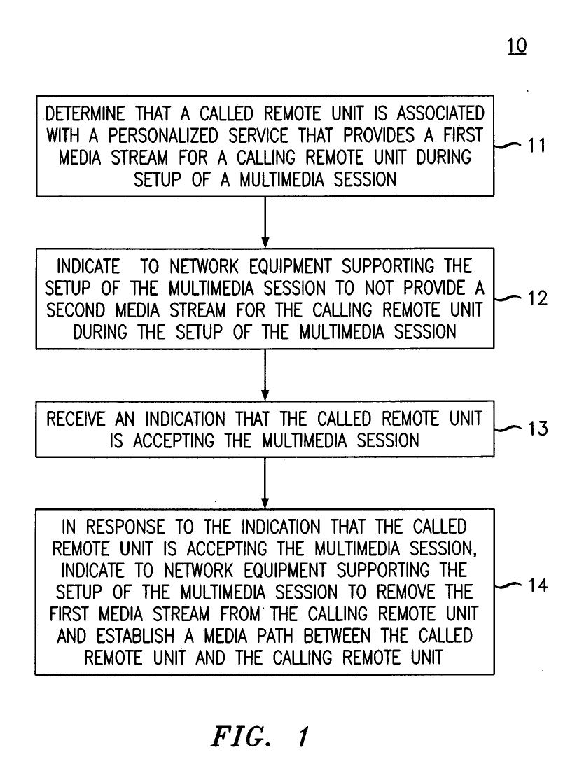

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

To address the need to manage multiple media streams within the communication network rather than at the user equipment, the network may employ a method such as that depicted in diagram 10 of FIG. 1. The network determines (11) that a called remote unit is associated with a personalized service that provides a first media stream for a calling remote unit during setup of a multimedia session. The network then indicates (12) to network equipment supporting the setup of the multimedia session to not provide a second media stream for the calling remote unit during the setup of the session. In response to receiving (13) an indication that the called remote unit is accepting the multimedia session, the network indicates (14) to network equipment to remove the first media stream from the calling remote unit and establish a media path between the called remote unit and the calling remote unit.

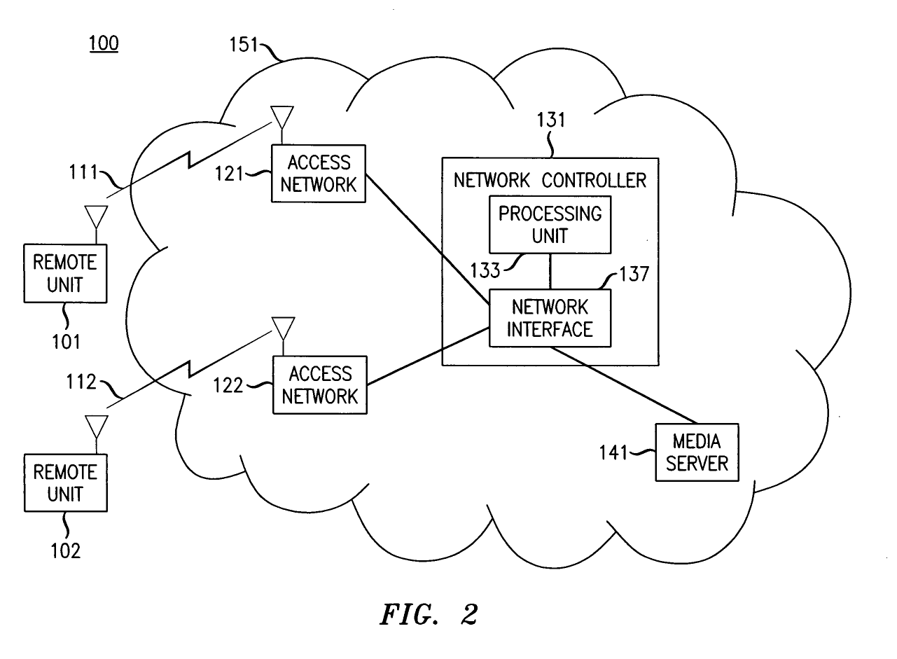

The present invention can be more fully understood with reference to FIGS. 2-5. FIG. 2 is a block diagram depiction of a wireless communication system 100 in accordance with multiple embodiments of the present invention. At present, standards bodies such as 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.3gpp.org/, http://www.3gpp2.com/, http://www.ieee802.org/, and http://www.wimaxforum.org/ respectively.) Communication system 100 represents a system having access networks (ANs) that may be based on different technologies. For example, each may be based on one of the 3GPP, 3GPP2, or WiMAX (Worldwide Interoperability for Microwave Access) technologies. Alternative embodiments of the present invention may also be implemented in communication systems in which ANs 121 and 122 employ the same technologies.

Communication system 100 is depicted in a very generalized manner. Communication network 151 comprises ANs 121 and 122, network controller 131, and media server 141. In particular, AN 121 is shown communicating with remote unit 101 via wireless interface 111 and AN 122 is shown communicating with remote unit 102 via wireless interface 112, these interfaces being in accordance with the particular access technology utilized by each of ANs 121 and 122.

Those skilled in the art will recognize that FIG. 2 does not depict all of the network equipment necessary for system 100 to operate but only those system components and logical entities particularly relevant to the description of embodiments herein. For example, ANs are known to comprise one or more devices such as base transceiver stations (BTSs), base site controllers (BSCs) (which may include selection and distribution units (SDUs)), mobile switching centers (MSCs), or radio network controllers (RNCs). However, none of these devices are specifically shown in FIG. 2.

FIG. 2 depicts network controller 131 as comprising processing unit 133 and network interface 137. In general, components such as processing units and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, network controller 131 represents a known device that has been adapted, in accordance with the description herein, to implement multiple embodiments of the present invention. Furthermore, those skilled in the art will recognize that aspects of the present invention may be implemented in and across various physical components and none are necessarily limited to single platform implementations. For example, processing unit 133 and network interface 137 may be implemented in or across one or more network components, such as one or more application servers.

Remote units 101 and 102 are shown communicating via a technology-dependent, wireless interface. Remote units, wireless devices, subscriber stations (SSs) or user equipment (UEs), may be thought of as mobile stations (MSs); however, remote units are not necessarily wireless, mobile, nor able to move. In addition, remote unit platforms are known to refer to a wide variety of consumer electronic platforms such as, but not limited to, landline phones, Voice over IP (VoIP) phones, mobile stations (MSs), access terminals (ATs), terminal equipment, mobile devices, gaming devices, personal computers, personal digital assistants (PDAs), and any other communication unit that obtains service from a service provider.

Operation of embodiments in accordance with the present invention occurs substantially as follows, first with reference to FIG. 2. FIG. 2 is a block diagram depiction of wireless communication system 100 in accordance with multiple embodiments of the present invention. Network controller 131 is depicted as comprising processing unit 133 and network interface 137 which is able to send and receive messaging using a plurality of communication protocols. Processing unit 133 determines that called remote unit 102 is associated with a personalized service that provides a first media stream for calling remote unit 101 during setup of a multimedia session. Processing unit 133 then indicates via network interface 137 to not provide a second media stream for calling remote unit 101 during the setup of the multimedia session. This indication is sent to network equipment supporting the setup of the multimedia session and, depending on the embodiment, may be sent to media server 141 via various other network components that are not depicted in network 151. This indication may take the form of either, or both, sending an invalid address for calling remote unit 101 or sending an indication that remote unit 102 has been put on hold.

Processing unit 133 at some point receives, via network interface 137, an indication that the called remote unit 102 is accepting the multimedia session (in the case where the session is a voice call, e.g., accepting may take the form of an answer indication for the call). In response to this indication acceptance, processing unit 133, via network interface 137, indicates to network equipment supporting the setup of the multimedia session to remove the first media stream from calling remote unit 101 and to establish a media path between called remote unit 102 and calling remote unit 101.

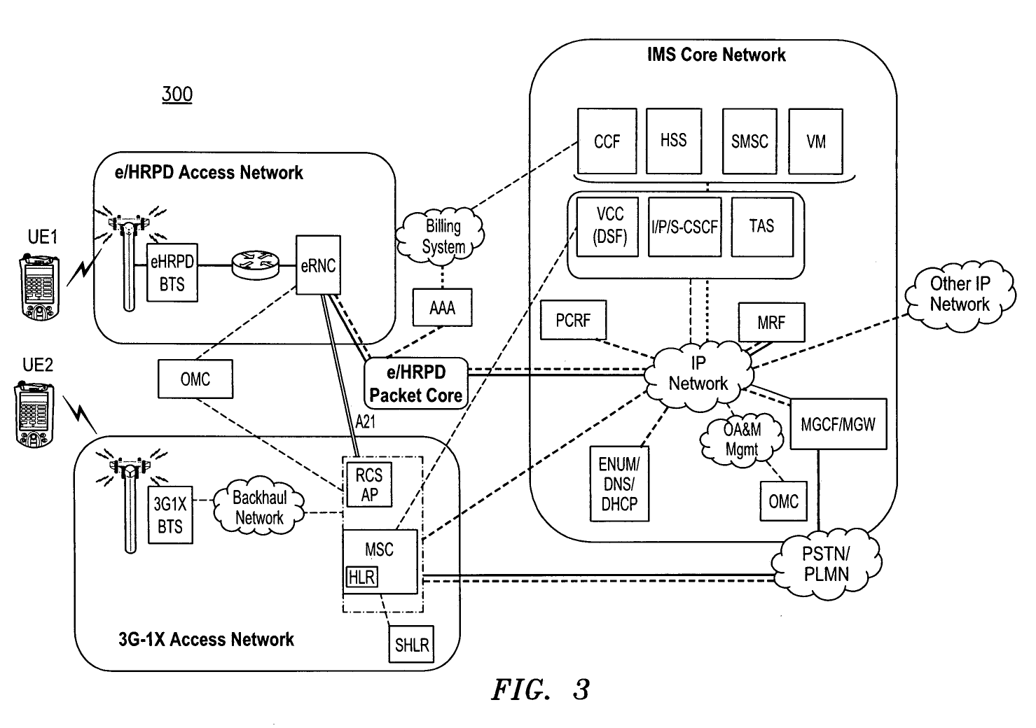

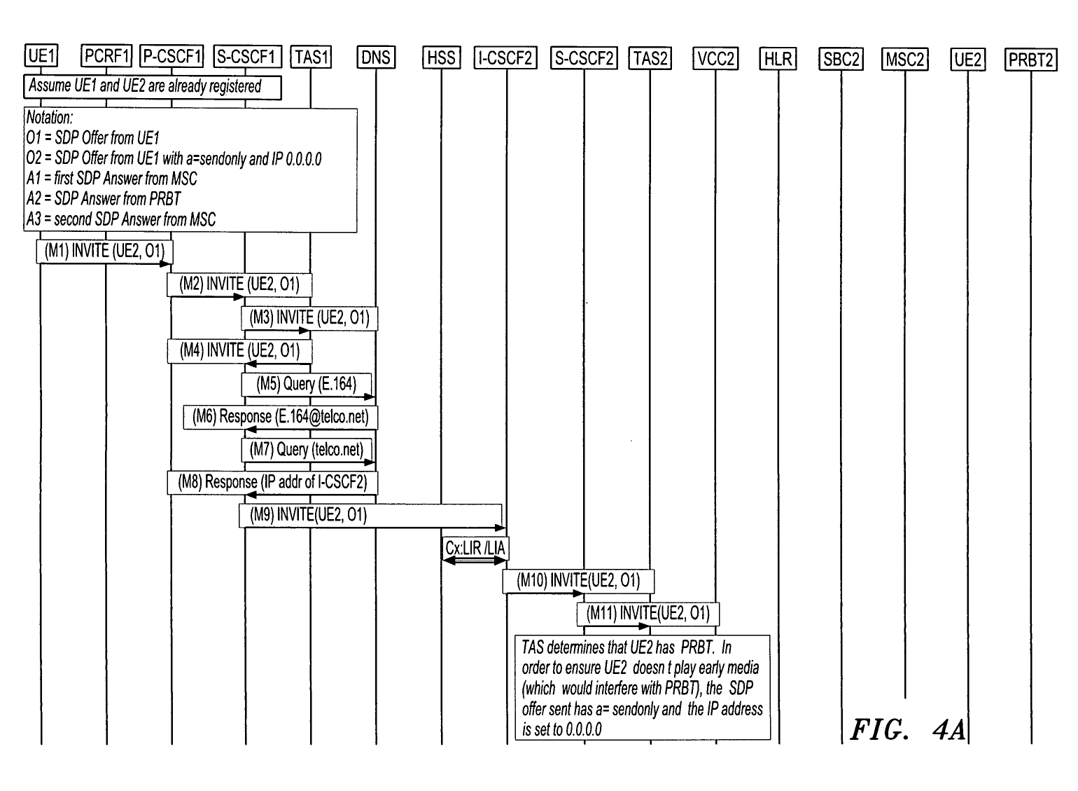

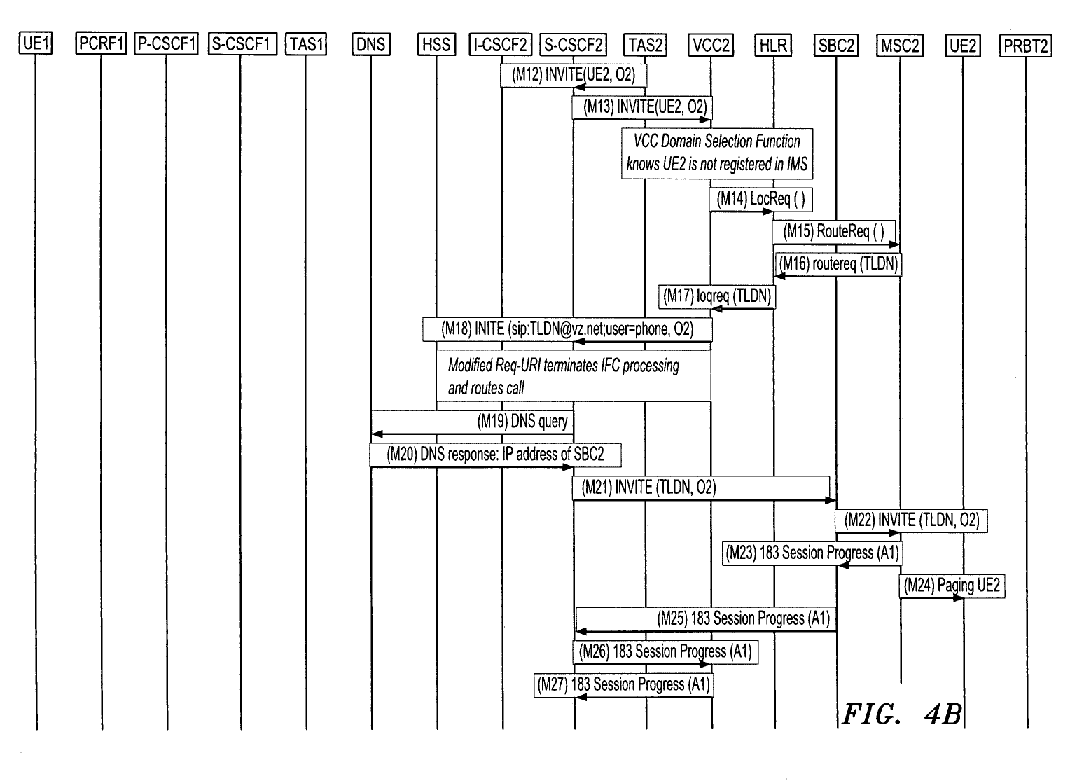

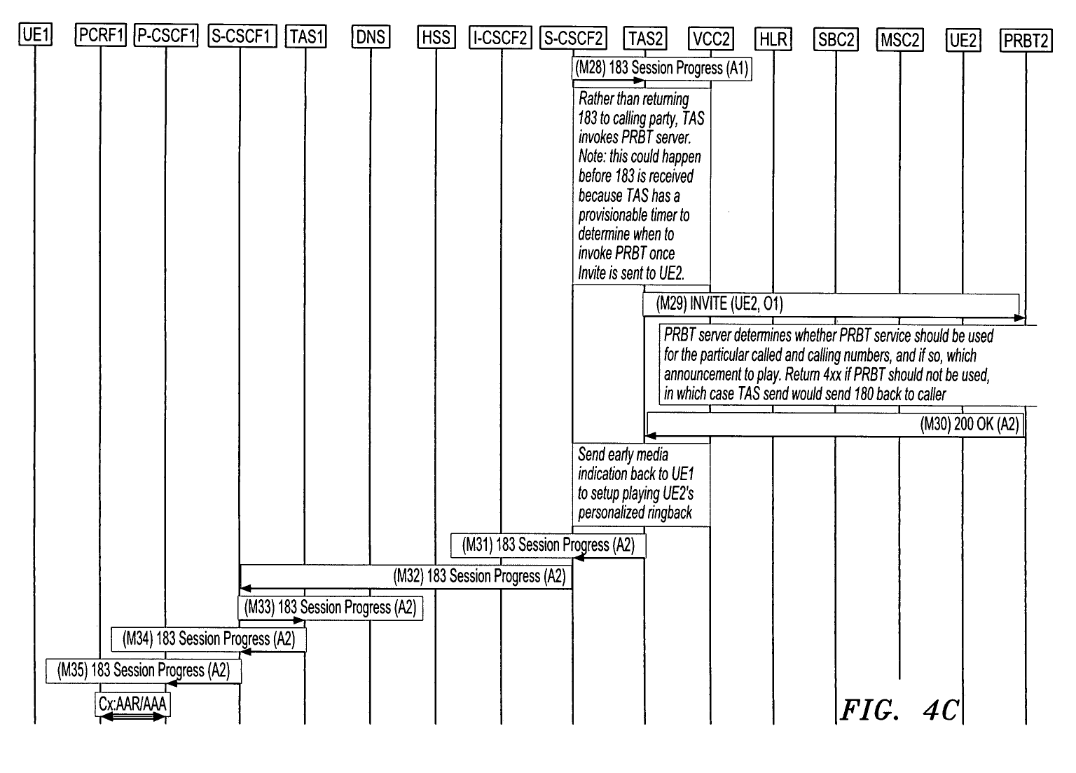

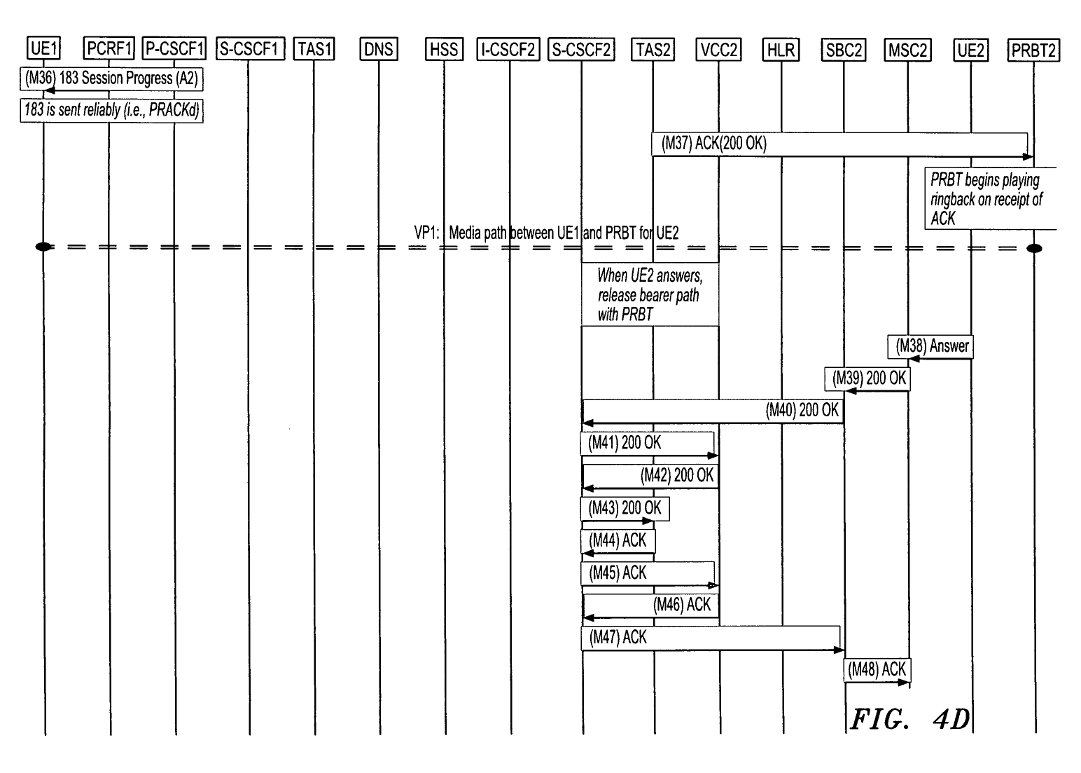

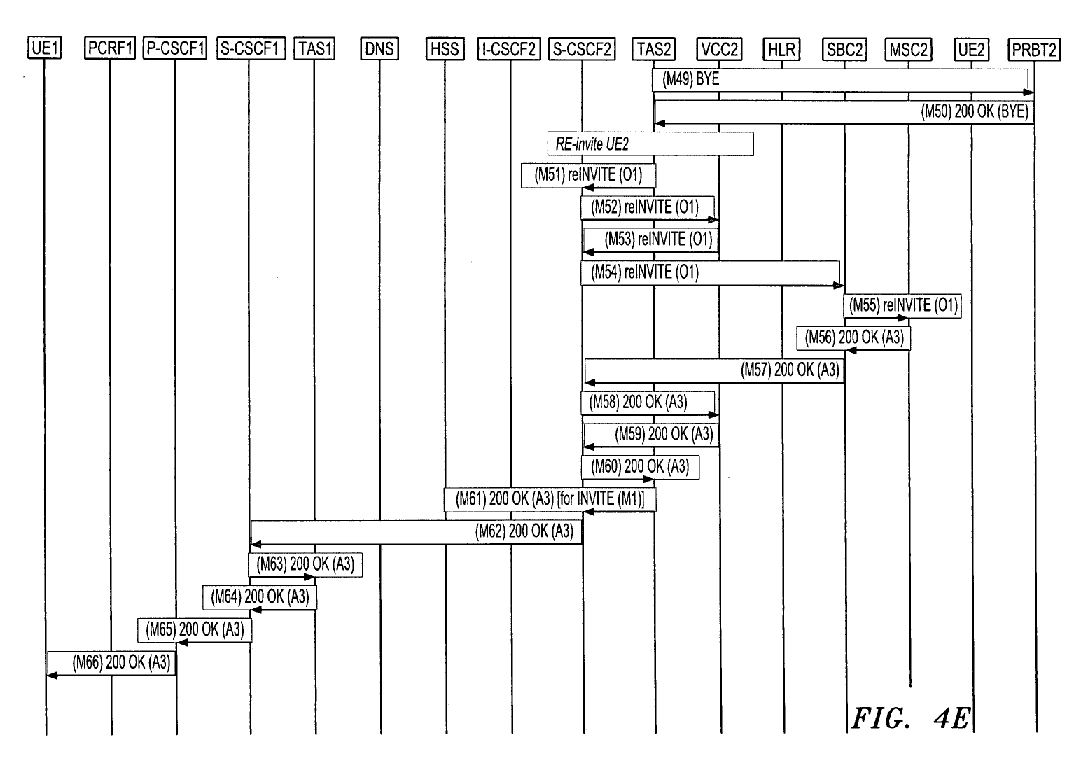

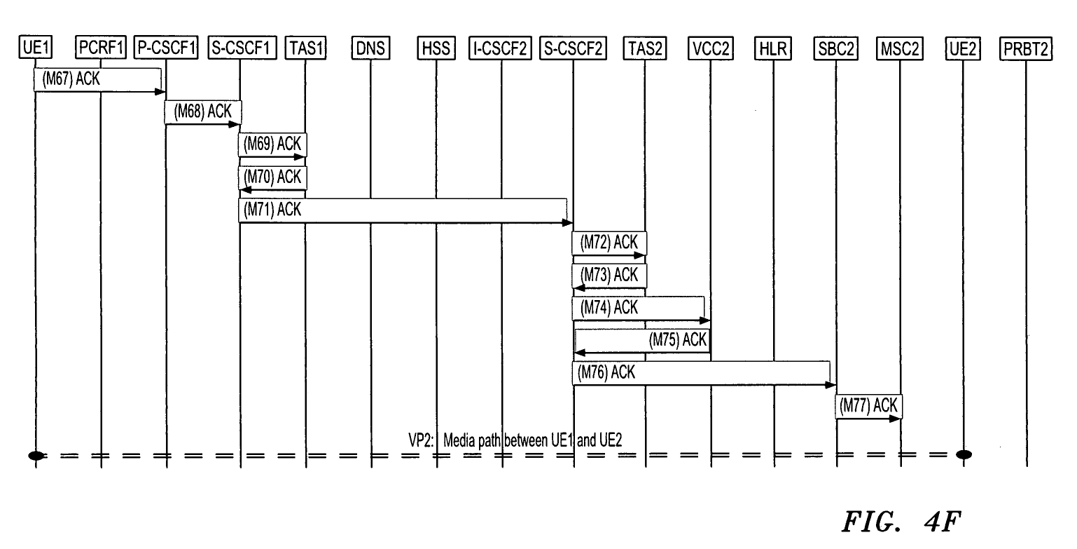

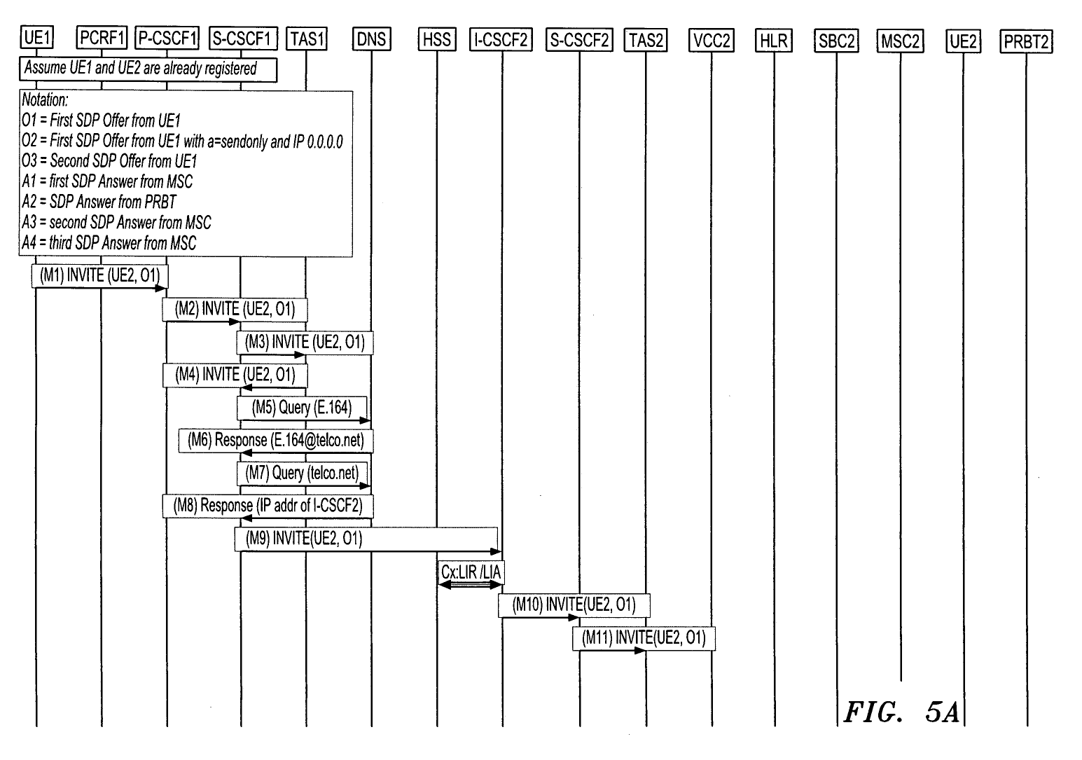

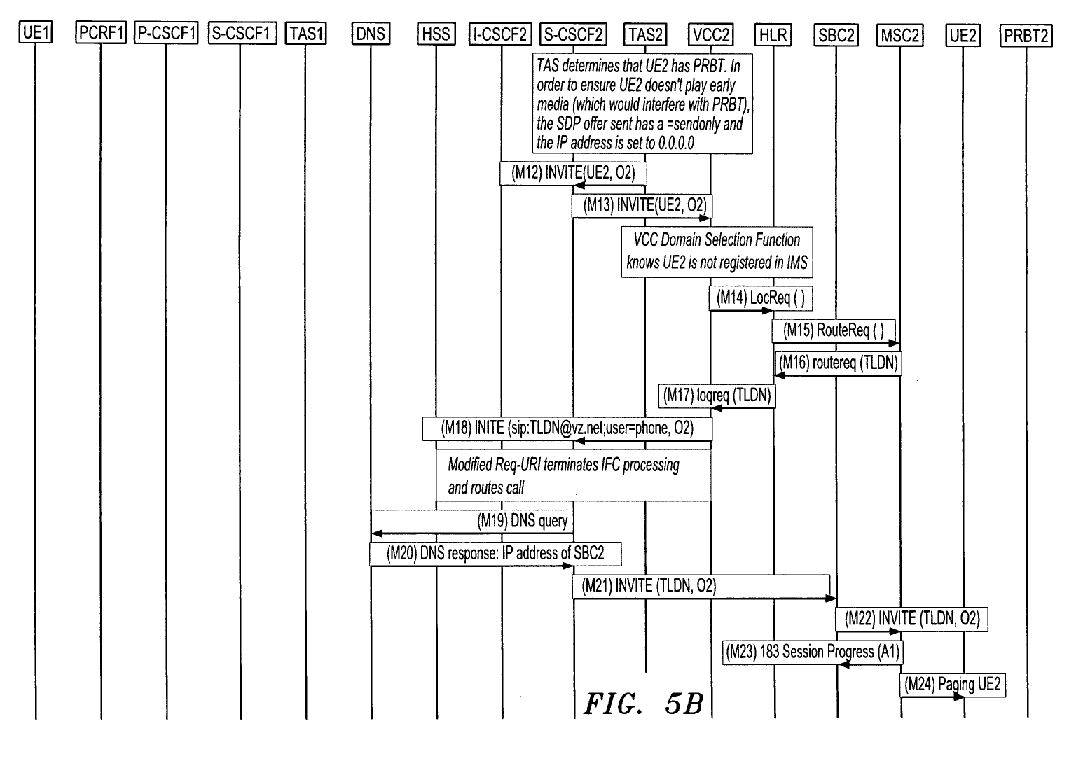

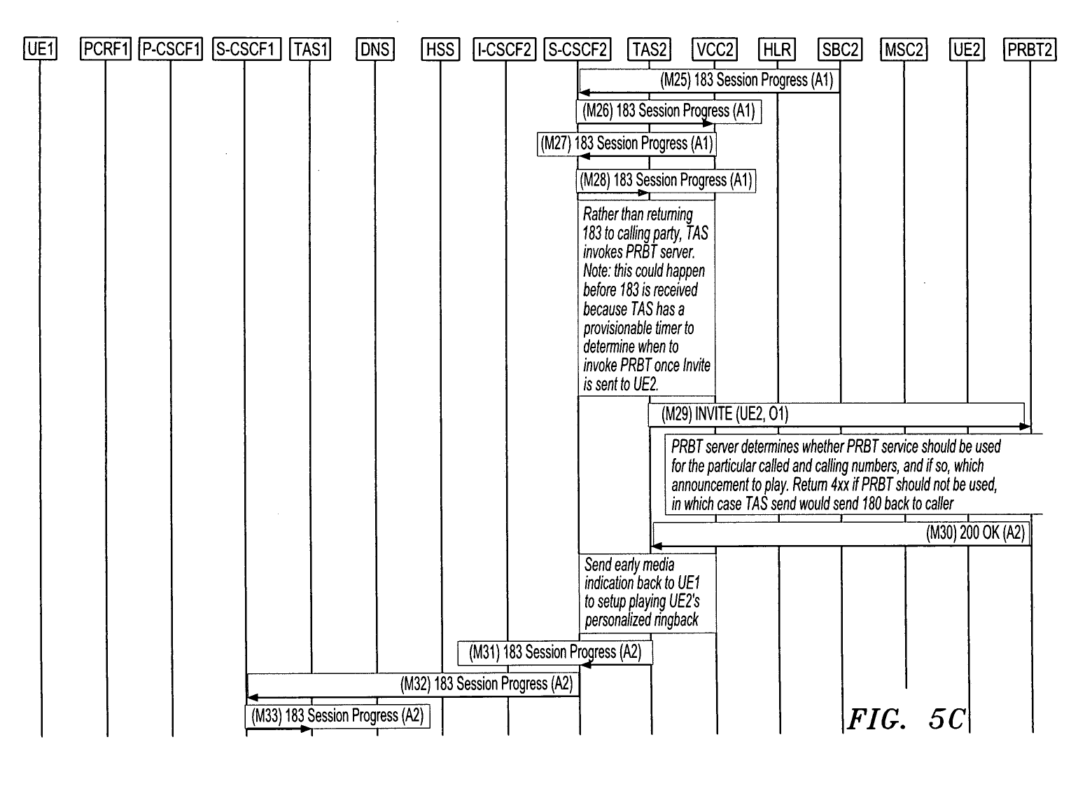

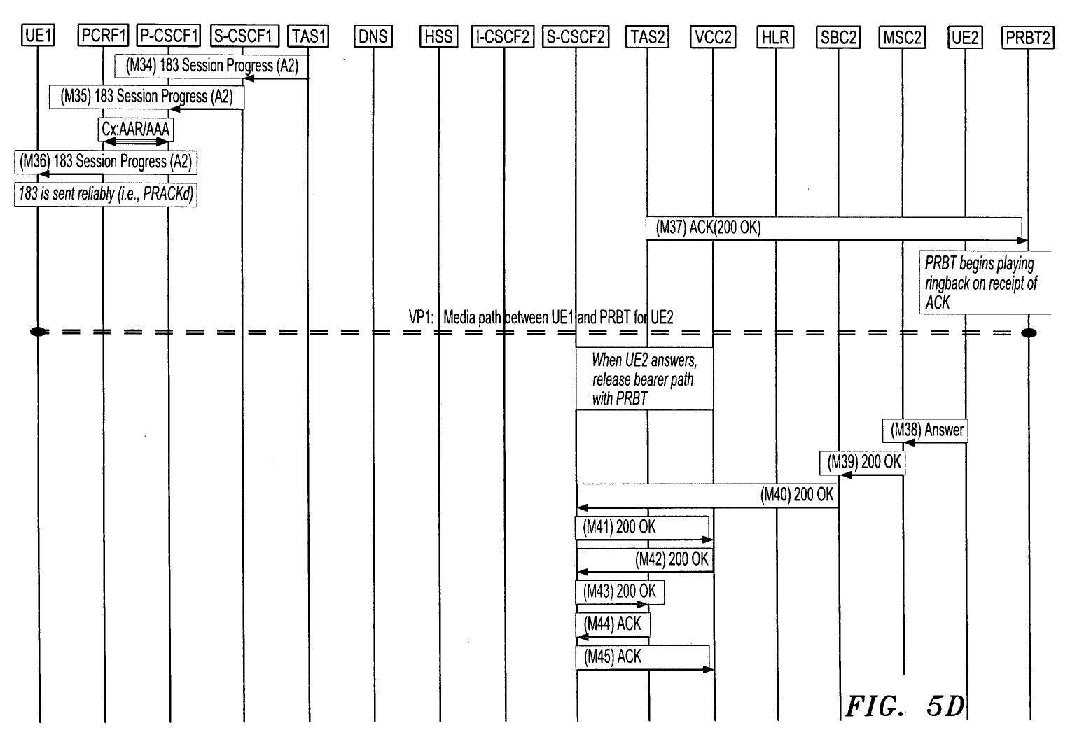

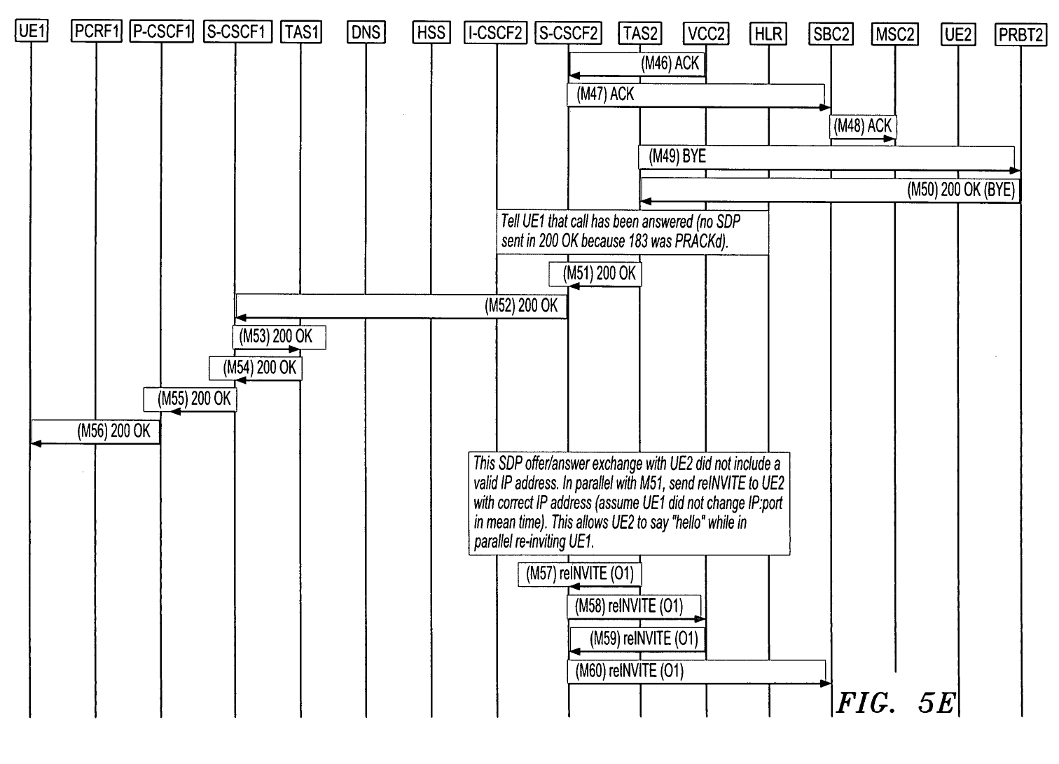

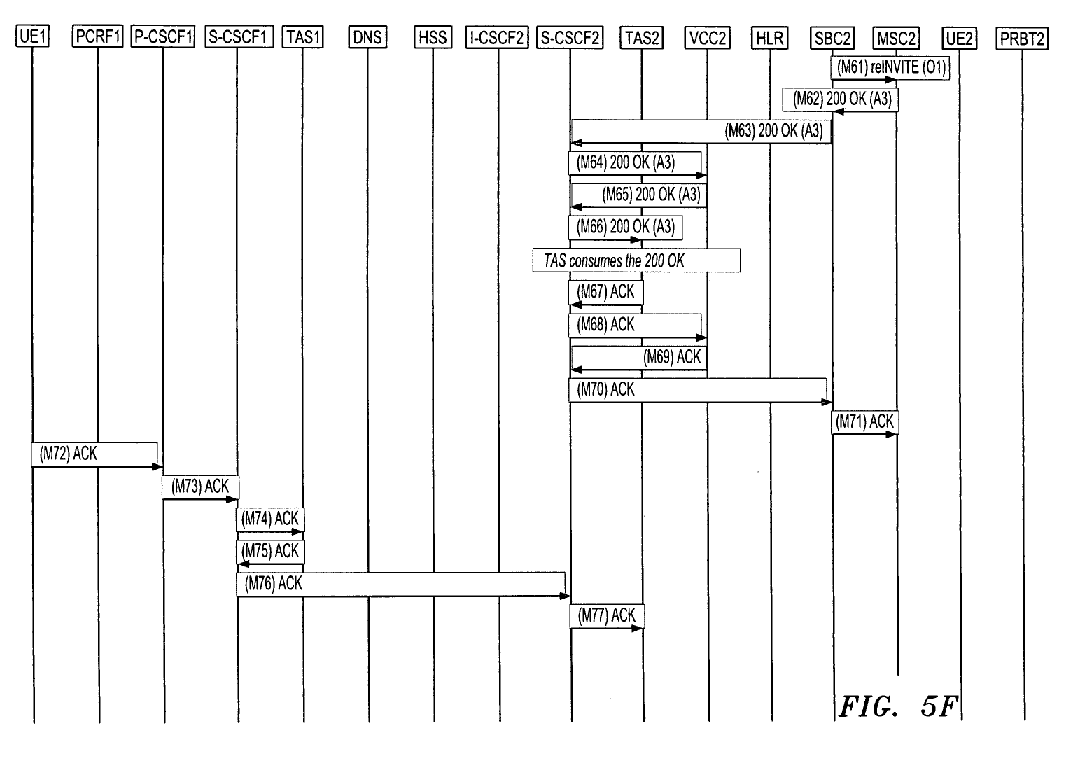

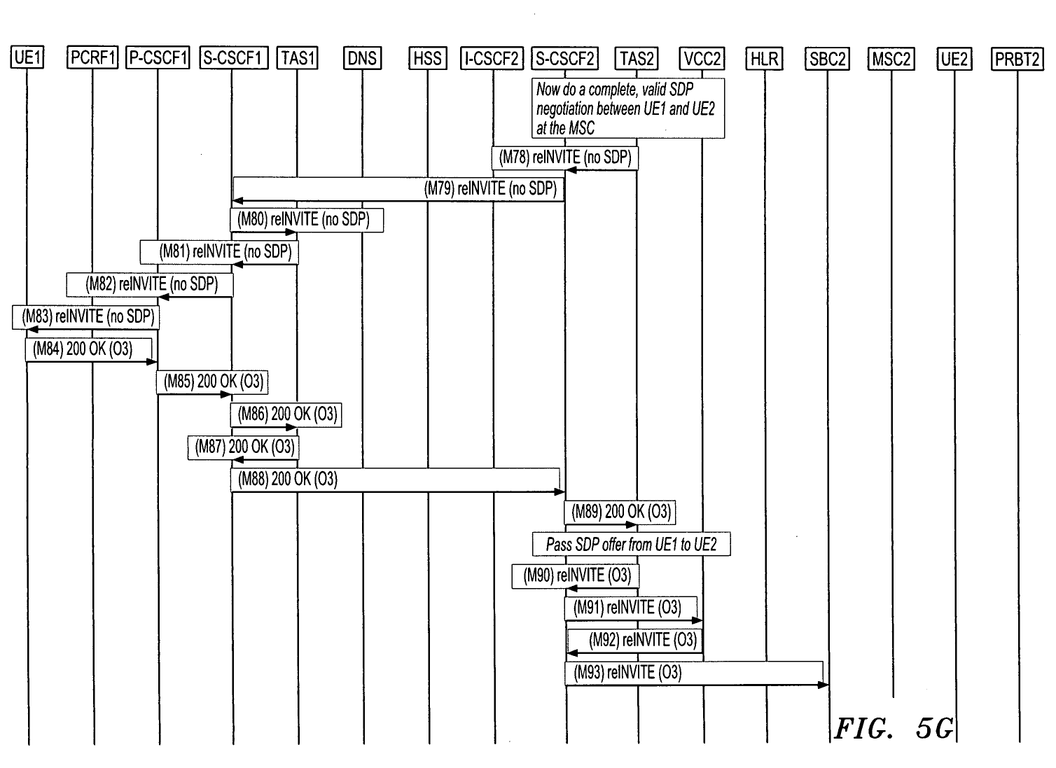

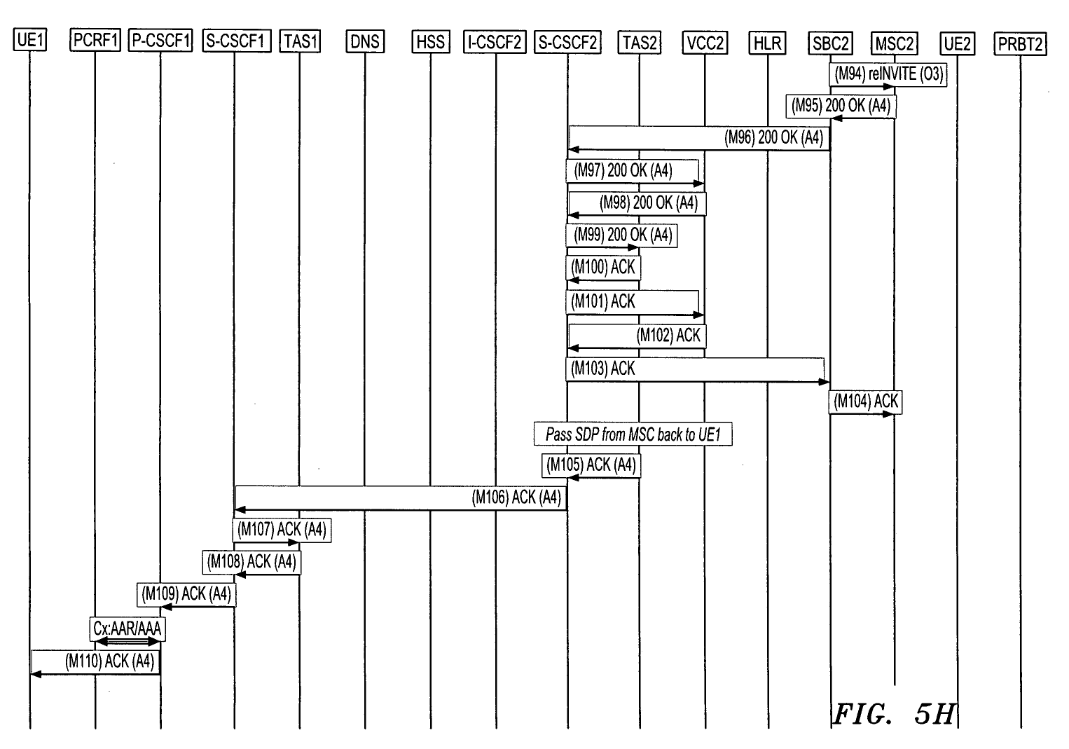

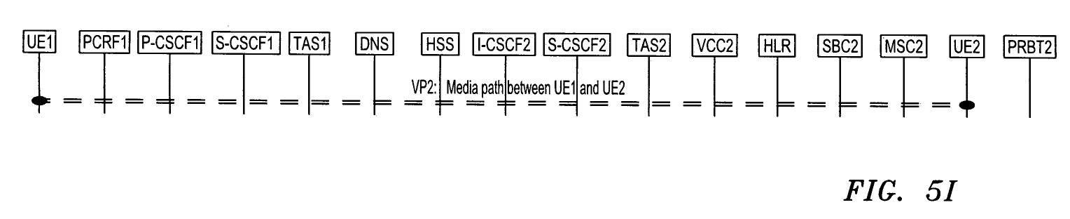

To provide a greater degree of detail in making and using various aspects of the present invention, a description of certain, quite specific, embodiments follows for the sake of example. FIG. 3 provides a detailed block diagram depiction of a wireless communication system 300 in accordance with certain of these embodiments. FIGS. 4 and 5, provide exemplary signaling flow diagrams that depict media session setup between UEs. In particular, FIG. 4 depicts media session setup between UEs that support SIP forking, while FIG. 5 depicts media session setup between UEs that do not support SIP forking.

In some IMS (IP Multimedia Subsystem)/SIP-controlled VoIP (Voice over Internet Protocol) call scenarios, multiple endpoints may simultaneously play media to an originating device. One example device is a dual-mode, wireless VoIP phone (eg., VoIP over CDMA-EVDO Revision A packet data/CDMA-3G1x circuit cellular). One example of multiple media streams is two different ringing tones being sent to a calling party (e.g., a personalized ringtone of the called party sent by a SIP server vs. a standard network ringtone sent by a wireless switch serving the called party), as could occur if a dual-mode VoIP phone had a Personalized Ringback Tone (PRBT) service. (A PRBT service allows a user to substitute music or other greetings for the standard ringback tone heard by someone calling that device.)

In such scenarios, it is desirable for the IMS/SIP server controlling the call to manage the multiple media streams so that a given device hears only one media stream (e.g., the calling party hears only one ringtone). This is desirable to: a) prevent incoherent mixing of packets from multiple media streams, and b) make efficient utilization of the over-the-air, radio frequency bandwidth to a wireless device (i.e., the network prevents undesired media streams from occurring rather than delivering multiple media streams to the mobile device and relying on device intelligence to reject the undesired streams).

A number of IMS application server/SIP server embodiments described in detail below enable the management of multiple media streams efficiently (e.g., by minimizing voice clipping). These embodiments are described in the context of a particular scenario in which a VoIP device that has a PRBT feature roams into a circuit celluar network and then receives a call; however, the same concepts can also be applied to systems having other network types (e.g., HRPD, GSM and/or UMTS) or other call processing features in which multiple endpoints may want to play media prior to a media session answer.

In certain embodiments, an IMS/SIP server controlling a call or media session will take steps to prevent multiple media paths from interfering, yet still connect the call/session when answer occurs. The key steps taken by such an IMS/SIP server may include:

1. Perform the normal call setup actions but send an invalid IP address for the calling party when initially routing the call termination to the called party, so that ringback from the far-end is not possible and therefore cannot interfere with other media that the IMS/SIP server knows needs to be played to the calling party, e.g., a personalized/customized ringback tone.

2. Once the called party answers, the IMS/SIP server takes a number of actions in parallel to efficiently setup the voice path between calling and called parties. These actions vary slightly depending on whether the devices are assumed to support SIP forking, which is the ability of the phone's software to deal with multiple, concurrent SIP dialogs.

3. In the case of the simpler, non-forking devices (see e.g. FIG. 5), the IMS/SIP server first tells the calling party that the call has been answered, and then in parallel, sends the valid IP address of the calling party to the called party so that the person answering the phone can say “hello” with a reduced chance of voice clipping. Finally, the IMS/SIP server then coordinates a renegotiation of media path details between the two ends of the call so that they can be connected in a proper manner per the SIP protocol. Note: This renegotiation is desirable, for example, because it is theoretically possible (although unlikely) that the calling device and PRBT server changed UDP ports while the caller was listening to the customized ringing tone; the SIP protocols provides this flexibility. Therefore, upon answer it is necessary to account for this possibility and renegotiate the terms of the media agreement between the two ends of the call. The IMS/SIP server does this because it knows the original IP address sent to the called party was invalid and needs to be corrected.

4. In the case of devices that support forking (see e.g. FIG. 4), the media agreement is also renegotiated but because the originating device handles SIP forking, the valid IP address can be communicated as part of the renegotiation, and the fact that the call was answered can also be handled as part of the renegotiation. In other words, the IMS/SIP server needs fewer steps in the case of more advanced devices.

Again, with reference to FIGS. 4 and 5, UE1 and UE2 are dual-mode, wireless VoIP phones A and B, respectively, as referred to below. Suppose A calls B, where B subscribes to a Personalized Ringback Tone (PRBT) service. Further suppose that B is homed in the IMS network but is currently roaming in a 3G-1x network at the time of the call (in other words, B is in 3G-1x-only coverage at the time of the call, so when B's user talks, the voice is carried via a circuit connection from the cellular network rather than via an IP connection).

The desired outcome of this scenario is: A calls B, A hears whatever ringing tone B has previously selected for A to hear, while the 3G-1x system is paging B, and B's mobile phone is ringing. Once B answers, A stops hearing the customized/personalized ringing tone and is able to talk with B. In other words, this is the normal behavior associated with custom ringback tone service provided in the circuit world; it is desirable, of course, to provide this same service and outcome when VoIP technology is involved.

Note that B's phone service is controlled by the IMS network because B is homed in the IMS network (i.e., calls to B are initially routed to IMS rather than 3G-1x). Depending on the embodiment, there may be three network elements within the IMS network assigned to implement the call logic for B's phone service: the Telephone Application Server (TAS), which controls call processing services like PRBT; the Domain Selection Function of the Voice Call Continuity Application Server (VCC/DSF), which delivers calls to B when B is roaming in 3G-1x-only coverage; and the Personalized Ringback Tone Server (PRBT Server), which stores B's choices for ringing tones, as well as which callers should hear which tones, and plays back the selected ringtones on command from the TAS.

The message flows depicted in FIGS. 4 and 5 are based on a standard IMS call flow for the scenario of a termination to a dual-mode device roaming in cellular. However, a key change to the standard IMS call flow is illustrated by message 12 (M12 in both FIGS. 4 and 5). When the call is initially sent into the cellular network, the IP address of the originating party is invalid (e.g., an IP address of 0.0.0.0) and the media description sent indicates that the calling party has put B on hold (i.e., a=sendonly in SDP). This informs and guarantees that the cellular switch serving B cannot send ringback to A, which is the normal behavior of a cellular switch (e.g., if a Chicago mobile goes to Florida and then someone calls that mobile, the ringing heard by the caller just before answer is provided by the Florida cellular switch).

The difference between the flows depicted in FIGS. 4 and 5 occurs at the point where B answers. In the case of simpler, non-forking devices (as depicted in FIG. 5), the answer is relayed back to the calling party A in message 51, then in parallel, the valid IP address for A is sent to B in message 57, and finally, the media renegotiation is started in message 78, which results in the final media path between A and B after message 110. In the case of more advanced devices that support forking (as depicted in FIG. 4), the renegotiation is started essentially immediately after call answer. As part of this renegotiation the valid IP address of A is sent in message 51, and the valid response from B for the media negotiation is sent back to A in message 61, which also indicates to A that the call was answered.

The detailed and, at times, very specific description above is provided to effectively enable a person of skill in the art to make, use, and best practice the present invention in view of what is already known in the art. In the examples, specific architectures, specific message names, specific message field values, specific messaging formats, and specific messaging sequences are all provided for the purpose of illustrating possible embodiments of the present invention and should not be interpreted as restricting or limiting the scope of the broader inventive concepts.

The present invention may also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object being indicated. Some, but not all examples of techniques available for communicating or referencing the object being indicated include the conveyance of the object being indicated, the conveyance of an identifier of the object being indicated, the conveyance of information used to generate the object being indicated, the conveyance of some part or portion of the object being indicated, the conveyance of some derivation of the object being indicated, and the conveyance of some symbol representing the object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for managing multiple media streams during call setup comprising:
determining that a called remote unit is associated with a personalized service that provides a first media stream for a calling remote unit during setup of a multimedia session;
indicating to network equipment supporting the setup of the multimedia session to not provide a second media stream for the calling remote unit during the setup of the multimedia session;
receiving an indication that the called remote unit is accepting the multimedia session;
in response to the indication that the called remote unit is accepting the multimedia session, indicating to network equipment supporting the setup of the multimedia session to remove the first media stream from the calling remote unit and establish a media path between the called remote unit and the calling remote unit.

2. The method as recited in claim 1, wherein the personalized service that provides the first media stream for the calling remote unit comprises a personalized ringback tone service.

3. The method as recited in claim 1, wherein receiving the indication that the called remote unit is accepting the multimedia session comprises
receiving an indication that the called remote unit is answering a request for a session.

4. The method as recited in claim 1, wherein receiving the indication that the called remote unit is accepting the multimedia session comprises
receiving an indication that the called remote unit is answering a call.

5. The method as recited in claim 1, wherein indicating to network equipment supporting the setup of the multimedia session to not provide a second media stream for the calling remote unit during the setup of the multimedia session comprises
sending to the network equipment supporting the setup of the multimedia session an invalid address for the calling remote unit during the setup of the multimedia session.

6. The method as recited in claim 1, wherein indicating to network equipment supporting the setup of the multimedia session to remove the first media stream from the calling remote unit and establish a media path between the called remote unit and the calling remote unit comprises
sending to the network equipment supporting the setup of the multimedia session a valid address for the calling remote unit.

7. A network controller comprising:
a network interface adapted to send and receive messaging using a plurality of communication protocols;
a processing unit, communicatively coupled to the network interface,
adapted to determine that a called remote unit is associated with a personalized service that provides a first media stream for a calling remote unit during setup of a multimedia session,
adapted, via the network interface, to indicate to network equipment supporting the setup of the multimedia session to not provide a second media stream for the calling remote unit during the setup of the multimedia session,
adapted, via the network interface, to receive an indication that the called remote unit is accepting the multimedia session, and
adapted, via the network interface and in response to the indication that the called remote unit is accepting the multimedia session, to indicate to network equipment supporting the setup of the multimedia session to remove the first media stream from the calling remote unit and establish a media path between the called remote unit and the calling remote unit.

8. The network controller as recited in claim 7, wherein the network controller comprises an Internet Protocol Multimedia Subsystem (IMS)/Session Initiation Protocol (SIP) application server.

9. The network controller as recited in claim 7, wherein the called remote unit and the calling remote unit each comprise Voice over Internet Protocol (VoIP) phones.

10. The network controller as recited in claim 7, wherein being adapted to indicate to network equipment supporting the setup of the multimedia session to not provide a second media stream for the calling remote unit during the setup of the multimedia session comprises
being adapted to send to the network equipment supporting the setup of the multimedia session an invalid address for the calling remote unit during the setup of the multimedia session.

11. The network controller as recited in claim 7, wherein being adapted to indicate to network equipment supporting the setup of the multimedia session to remove the first media stream from the calling remote unit and establish a media path between the called remote unit and the calling remote unit comprises
being adapted to send to the network equipment supporting the setup of the multimedia session a valid address for the calling remote unit.

12. A computer readable medium containing executable computer program instructions which, when executed by a processing unit, cause the processing unit to perform steps comprising:
determining that a called remote unit is associated with a personalized service that provides a first media stream for a calling remote unit during setup of a multimedia session;
indicating to network equipment supporting the setup of the multimedia session to not provide a second media stream for the calling remote unit during the setup of the multimedia session;
receiving an indication that the called remote unit is accepting the multimedia session;
in response to the indication that the called remote unit is accepting the multimedia session, indicating to network equipment supporting the setup of the multimedia session to remove the first media stream from the calling remote unit and establish a media path between the called remote unit and the calling remote unit.

13. The computer readable medium as recited in claim 12, wherein the step of receiving the indication that the called remote unit is accepting the multimedia session comprises the step of
receiving an indication that the called remote unit is answering a request for a session.

14. The computer readable medium as recited in claim 12, wherein the step of receiving the indication that the called remote unit is accepting the multimedia session comprises the step of
receiving an indication that the called remote unit is answering a call.

15. The computer readable medium as recited in claim 12, wherein the step of indicating to network equipment supporting the setup of the multimedia session to not provide a second media stream for the calling remote unit during the setup of the multimedia session comprises the step of
sending to the network equipment supporting the setup of the multimedia session an invalid address for the calling remote unit during the setup of the multimedia session.

16. The computer readable medium as recited in claim 12, wherein the step of indicating to network equipment supporting the setup of the multimedia session to remove the first media stream from the calling remote unit and establish a media path between the called remote unit and the calling remote unit comprises the step of
sending to the network equipment supporting the setup of the multimedia session a valid address for the calling remote unit.
